(19) United States
(12) Patent Application Publication
(10) Pub. No.: US 2016/0281750 A1
(43) Pub. Date: Sep. 29, 2016

(54) INTERFACIAL SURFACE GENERATORS AND METHODS OF MANUFACTURE THEREOF

(71) Applicant: DOW GLOBAL TECHNOLOGIES LLC, Midland, MI (US)

(72) Inventors: Christopher J. Siler, Midland, MI (US); Joseph Dooley, Midland, MI (US); Jeffery D. Zawisza, Midland, MI (US); Patrick Chang D. Lee, Midland, MI (US); Daniel S. Woodman, Midland, MI (US)

(21) Appl. No.: 15/035,368

(22) PCT Filed: Nov. 13, 2014
(86) PCT No.: PCT/US2014/065429

§ 371 Date: May 9, 2016

Related U.S. Application Data
(60) Provisional application No. 61/904,789, filed on Nov. 15, 2013.

(51) Int. Cl. F15D 1/00; B33Y 80/00

(52) U.S. Cl. CPC F15D 1/0025; B33Y 80/00

(57) ABSTRACT

Disclosed herein is a an internal surface generator (300) comprising an inlet sub-element (302) comprising a plurality of inlet ports (302A-302D); an outlet sub-element (306) comprising outlet ports (306A-306D) that are equal in number to the inlet ports; and an intermediate sub-element (304) comprising non-linear passages (304A-304D) that are equal in number to the inlet ports or the outlet ports; where the intermediate sub-element contacts the inlet sub-element and the outlet sub-element and is operative to transport a fluid from the inlet ports to the outlet ports.

### BACKGROUND

This disclosure relates to interfacial surface generators, methods of manufacture thereof and to articles that use the interfacial surface generators.

Interfacial surface generators are devices that increase the number of layers in a multilayer fluid structure. The effective layer multiplication in these devices is obtained by the division of a multilayer fluid stream into a plurality of sub-streams, recombination of the sub-streams into a main stream and subsequent division and recombination until a desired number of layers is obtained.

Products that are manufactured using interfacial generators involve a number of multilayer films where an ordered arrangement of layers of various materials of particular layer thicknesses are desired. Exemplary products (manufactured by using interfacial surface generators) are those where optical, mechanical, or permeability effects are desired because of the interaction of contiguous layers of materials having different properties and layer thicknesses.

FIG. 1 depicts a traditional commercial interfacial surface generator 100 comprising an inlet end 106 adapted to receive fluid travelling along direction 200B, and outlet end 102 adapted to discharge the fluid along direction 200A, and a plurality of separate passage ways 104A, 104B and 104C connecting the inlet end 106 to the outlet end 102. The interfacial surface generator 100 comprises a plurality of sub-elements 202, 204, 206, and 208 that contact each other. Sub-element 208 receives an incoming fluid stream along direction 200B. The incoming fluid stream contacts sub-element 208 and is split up into three streams upon entering the three inlet ports 106A, 106B and 106C. The inlet ports 106B, 106A and 106C are arranged to be adjacent to each other in a horizontal plane. Inlet port 106A leads to passage 104A, inlet port 106B leads to passage 104B, and inlet port 106C leads to passage 104C, in the sub-elements 206 and 204. The fluid stream is therefore split by the three inlet ports 106A, 106B and 106C and travels in three passages 104A, 104B and 104C respectively through sub-elements 206 and 204 before reaching the outlet end 102, where it emanates from the outlet ports 102A, 102B and 102C respectively into an optional trapezoidal cavity 101 in element 202. Outlet port 102A corresponds to inlet port 106A (i.e., the stream entering inlet port 106A leaves the interfacial generator via outlet port 102A), while outlet port 102B corresponds to the inlet port 106B and outlet port 102C corresponds to inlet port 106C. The outlet ports 102A, 102C and 102B are arranged side-by-side in a vertical plane at the outlet end 102. The interfacial surface generator of the FIG. 1 thus divides the incoming stream 200B at the inlet end 106 and recombines it in a different configuration at the outlet end 102 where it exits along direction 200A. This ability of an interfacial surface generator to divide an incoming stream of materials into several layered branch streams, and then rearrange and restack the branch streams in another configuration creates new surface in the fluid as it travels through the interfacial generator.

The traditional interfacial surface generator 100 suffers from several drawbacks in that the passages 104A, 104B and 104C are always linear passages and are always comprised of planar sections. In other words, the passages 104A, 104B and 104C are always linear and are encompassed by walls that are always planar. Viscous fluids, especially polymers in their melt state, exhibit more uniform flow when there are no abrupt changes in the geometry of the flow channel through which they flow. This is why 90 degree turns containing sharp corners are avoided when possible. This avoidance of abrupt flow direction changes is usually referred to in the industry as “streamlining” and is very similar to the concept of streamlining the air flow around an automobile or airplane. The flow of a polymeric fluid through the linear passages of an interfacial surface generator as shown in FIG. 1 would involve several abrupt directional changes due to the inherent geometry and may lead to non-uniform flow in the device. This non-uniform flow may lead to layer non-uniformity and it may also contribute to the presence of defects in the finished product.

The utilization of only linear passages in an interfacial surface generator is therefore a drawback. This drawback (i.e., the presence of linear passages) is due to limitations in manufacturing techniques, which generally involve the removal of material from a solid block of material in order to form the passages. It is therefore desirable to have interfacial surface generators whose inlet ports, outlet ports and passages are designed to conform to directions that molten viscous and viscoelastic fluids such as polymers prefer to take during a manufacturing process.

### SUMMARY

Disclosed herein is a an interfacial surface generator comprising an inlet sub-element comprising a plurality of inlet ports; an outlet sub-element; and an intermediate sub-element; where the intermediate sub-element contacts the inlet sub-element and the outlet sub-element and is operative to transport a fluid from the inlet ports to the outlet ports.

Disclosed herein too is a method of manufacturing an intermediate sub-element of a interfacial surface generator comprising designing a model for an intermediate sub-element of a interfacial surface generator; where the intermediate sub-element comprises non-linear passages that contact inlet ports and outlet ports of the interfacial surface generator; transporting the model to an additive manufacturing machine; and disposing a plurality of layers in contact with each other to produce the intermediate sub-element.

Disclosed herein too is a method of manufacturing an intermediate sub-element of an interfacial surface generator comprising manufacturing a wax pattern that has a shape of an outer surface of the intermediate sub-element; where the wax pattern has holes drilled in a bottom; disposing wax inserts into the wax pattern; where the wax inserts have a shape of non-linear passages that are contained in the intermediate sub-element;
disposing a ceramic slurry into the wax pattern as well as on an outside surface of the wax pattern; curing and firing the slurry to form a ceramic shell; removing the wax pattern to form a ceramic mold; and pouring a metal into the ceramic mold to produce the intermediate sub-element.

### BRIEF DESCRIPTION OF THE FIGURES

FIG. 1 is a prior art depiction of an interfacial surface generator;

FIG. 2 is a depiction of an interfacial surface generator that contains non-linear passages disposed between an inlet sub-element and an outlet sub-element; and

FIG. 3 is a depiction of one method for manufacturing the interfacial surface generator using investment casting.

### DETAILED DESCRIPTION

Disclosed herein are interfacial surface generators that comprise inlet ports, outlet ports and passages (that contact the inlet ports and outlet ports) whose shapes and cross-sectional geometries are defined by the flow patterns of the fluids that are transported through them. The passages are not entirely linear and are defined by portions that are non-linear. In addition, the walls of the passages are not always planar. The cross-sectional geometry of the passages, the inlet ports and the outlet ports may be circular, ellipsoidal or other conical sections that are defined by the nature of the fluid flow occurring through them. The fluids that are transported through the interfacial surface generator are generally viscoelastic fluids or combinations of viscoelastic fluids with non-viscoelastic fluids.

Disclosed herein too is a method of manufacturing an interfacial surface generator that comprises adding material (i.e., an additive method) to build the interfacial surface generator. The method comprises manufacturing a sub-element that comprises non-linear passages and combining this element with one or more sub-elements that contain inlet ports and or outlet ports. The non-linear passages are defined by the flow patterns of the fluids that are transported through them. These passages comprise portions that are not linear and have cross-sectional geometries that encompass at least one curved surface. The sub-element comprising non-linear passages is generally manufactured by methods that involve additive manufacturing and/or investment casting.

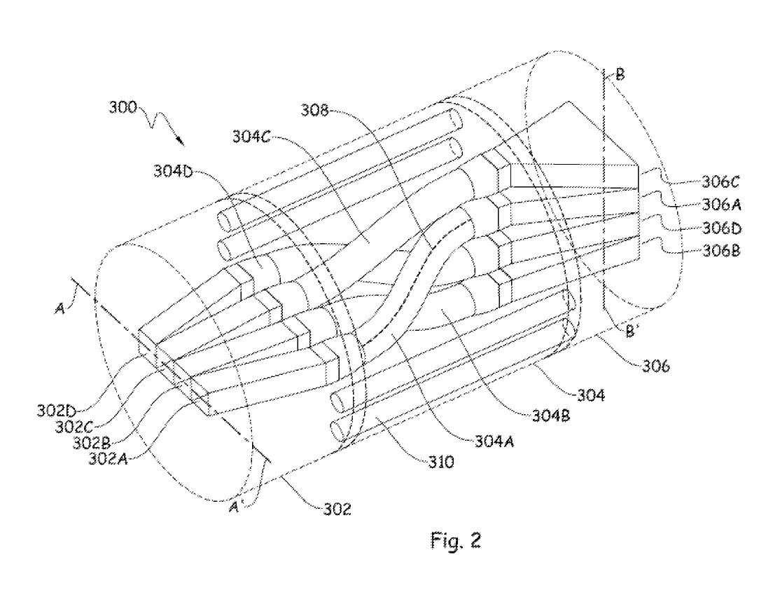

With reference now to the FIG. 2, an interfacial surface generator 300 of the present disclosure comprises an inlet sub-element 302 that contains a plurality of inlet ports 302A, 302B, 302C and 302D through which a fluid enters the generator 300. The inlet sub-element 302 contacts an intermediate sub-element 304 that contains the non-linear passages 304A, 304B, 304C and 304D that are in fluid communication with the inlet ports 302A, 302B, 302C and 302D respectively. The intermediate sub-element contacts the outlet sub-element 306 that contains a plurality of outlet ports 306A, 306B, 306C and 306D. In the FIG. 2, the inlet port 302A contacts the non-linear passage 304A which contacts the outlet port 306A. In the FIG. 2, a fluid that enters a port labeled A, B, C or D respectively, travels through passages labeled A, B, C or D respectively and exits at an outlet port labeled A, B, C or D respectively. In short, a fluid stream that enters inlet port 302A, travels through passage 304A and exits at port 306A, while a fluid stream that enters inlet port 302D, travels through passage 304D and exits at port 306D. It is to be noted that the inlet sub-element, the intermediate sub-element and the outlet sub-element can be in the form of a single, unitary, monolithic indivisible piece.

As can be seen in the FIG. 2, the inlet ports 302A, 302B, 302C and 302D are arranged to lie horizontally (along axis A-A′), while the outlet ports are 306A, 306B, 306C and 306D are arranged to lie at 90 degrees (along axis B-B′) to the inlet ports though not in the same order. In the FIG. 2, the outlet ports are arranged vertically from top to bottom as 306C, 306A, 306D and 306B.

The inlet ports 302A, 302B, 302C and 302D in the FIG. 2 are shown to have a square or rectangular cross-sectional area, but can also be circular if desired. While these inlet ports are arranged horizontally on plane alongside each other, they may also be arranged to lie vertically one on top of the other. They may also be arranged to lie in a plane that is not horizontal or vertical.

The non-linear passages 304A, 304B, 304C and 304D may have a square or rectangular cross-sectional area at the point of contact with the inlet ports 302A, 302B, 302C and 302D respectively or with the outlet ports 306A, 306B, 306C and 306D respectively. However, the shape of the cross-section of the passages may be transitioned from being square to one that includes least one curved surface. The curved surface can be a circle, a semi-circle, a conical section or a portion of a conical section (e.g., an ellipse, a portion of an ellipse, a parabola, a portion of a parabola, or the like). In an exemplary embodiment, the non-linear passages have a circular cross-sectional area.

Circular channels minimize the so called “secondary flow”. Secondary flow is a small magnitude flow that occurs perpendicular to the main flow direction due to elasticity of the polymers. This causes layer non-uniformity (elastic layer rearrangement). In order to minimize secondary flow, it is desirable to have non-linear passages that have a circular cross-section.

In one embodiment, the non-linearity of the passages 304A, 304B, 304C and 304D are defined by the flow characteristics of the fluid. In an embodiment, the trajectory of the individual passages 304A, 304B, 304C or 304D may be defined by a longitudinal axis 308 that passes through the center of the cross-sectional area of the passage from the end that contacts the inlet sub-element 302 to the opposite end that contacts the outlet sub-element element 306. The path of the longitudinal axis may be defined by a spline function that is defined by the fluid that is transported from the inlet sub-element to the outlet sub-element. In an exemplary embodiment, the fluid is a molten polymer.

In one embodiment, a spline function can be used to determine the shape of the non-linear passages. A spline is a function that has specified values at a finite number of points and consists of segments of polynomial functions joined smoothly at these points, enabling it to be used for approximation and interpolation of functions.

A quadratic parametric spline may be written as

P=a₂t²+a₁t+a₀

where P is a point on the curve, a₀, a₁ and a₂ are three vectors defining the curve and t is the parameter. The curve passes through three points labelled P₀, P₁ and P₂. By convention the curve starts from point P₀ with parameter value t=0, goes through point P₁ when t=t1 (0<t1<1) and finishes at P₂ when t=1. Using these conventions the three a vectors can be solved for as follows:

t=0 P₀=a₀

t=1 P₂=a₂a₁+a₀

t=t₁ P₁=a₂t₁²a₁t₁+a₀

The solving of the vectors provides a solution to the shape of the non-linear passage. The non-linear passages 304A, 304B, 304C and 304D contact the outlet ports 306A, 306B, 306C and 306D at a end that is opposed to the end that contacts the inlet ports. As can be seen in the FIG. 2, the outlet ports are generally arranged to be in a straight line (e.g., axis B-B′) along a plane that is different from the plane that includes the inlet ports (e.g., axis A-A′). As stated above, the order of the outlet ports are different from the inlet ports.

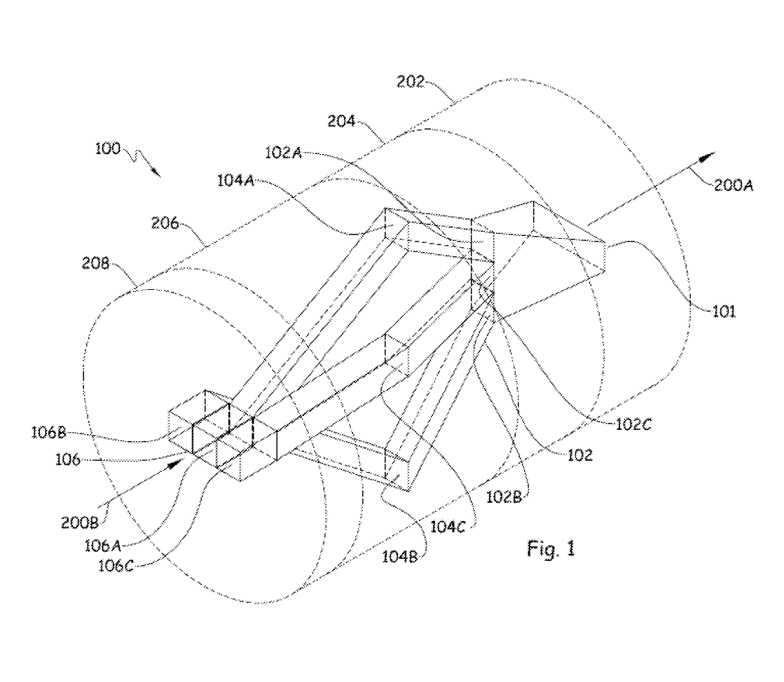

The intermediate sub-element 304 is locked into position between the inlet sub-element 302 and the outlet sub-element 306 by locating screws 310. A plurality of combinations of the inlet sub-element, the intermediate sub-element and the outlet sub-element may be disposed in a device such as an extruder. In addition, while the FIGS. 1 and 2 depict three and four passages respectively, it is possible for the sub-elements to contain greater than or equal to 10 passages, preferably greater than 20 passages, and more preferably greater than 50 passages if desired.

In one embodiment, in one method of manufacturing the interfacial surface generator, the inlet sub-element and the outlet sub-element may be manufactured using molding and/or alternatively machining a block of metal, ceramic or plastic. It is desirable for the material used in the outlet sub-element and the inlet sub-element to having a higher melting point than that of the fluid that it is used to transport. The metal may be stainless steel (e.g., SS304, SS316), titanium, titanium aluminum alloys, or the like. Suitable ceramics are silica, quartz, alumina, of the like, or a combination comprising at least one of the foregoing ceramics. Suitable polymers are high glass transition temperature polymers such as polyimides, polyether ether ketones, polyether ketones, polyether ketone ketones, polysulfones, polyetherimides, or the like, or a combination comprising at least one of the foregoing high temperature polymers.

In one embodiment, the manufacturing of the interfacial surface generator may be accomplished using similar methods for the inlet sub-element, the outlet sub-element, and the intermediate sub-element. In this mode of manufacturing, additive manufacturing and/or investment casting may be used to produce the inlet sub-element, the outlet sub-element, and the intermediate sub-element.

In another embodiment, the manufacturing of the interfacial surface generator may be accomplished using a first method for producing the inlet sub-element and the outlet sub-element and a second method for using the intermediate sub-element. In this mode of manufacturing, the inlet sub-element and the outlet sub-element may be manufactured by methods involving material removal techniques such as drilling, milling, slotting, electro-discharge machining, turning on a lathe, and the like, while the intermediate sub-elements that comprises the non-linear passages is manufactured by additive manufacturing and/or investment casting. Additive manufacturing and/or investment casting permit the manufacturing of the non-linear passages, which are difficult to manufacture by material removal techniques such as drilling, milling, laser cutting, slotting, electro-discharge machining, turning on a lathe, and the like. In an exemplary embodiment, it is desirable to manufacture the inlet sub-element and the outlet sub-element by methods that involve material removal techniques, while the intermediate sub-element is manufactured using additive manufacturing and/or investment casting.

The manufacturing description henceforth will be dedicated to the production of the intermediate sub-element by additive manufacturing and/or investment casting.

In one embodiment, the intermediate sub-element comprising the non-linear passages is manufactured by additive manufacturing. The manufacturing of curved internal passages is difficult or sometimes even impossible when using traditional manufacturing processes that use material removal to impart desired structure to a component. In order to circumvent these difficulties additive manufacturing is used to produce the intermediate sub-element.

Additive manufacturing or 3D printing is a process of making a three-dimensional solid object of virtually any shape from a digital model. 3D printing is achieved using an additive process, where successive layers of material are laid down in different shapes. 3D printing is also considered distinct from traditional machining techniques, which mostly rely on the removal of material by methods such as cutting or drilling (subtractive processes). Additive manufacturing processes are used to fabricate components having relatively complex three dimensional geometries, including components with internal surfaces defining internal passages including internal hollow areas, internal channels, internal openings, or the like.

In an additive-manufacturing process, a model, such as a design model, of the intermediate sub-element is first defined. For example, the model may be designed with computer aided design (CAD) software. The spline functions and/or the power law equations that define the shape of the non-linear passages may be included or incorporated as code in the computer aided design. The model may include 3D numeric coordinates of the entire configuration of the intermediate sub-element including both external and internal surfaces. The model may include a number of successive 2D cross-sectional slices that together form the 3D component. In an exemplary embodiment, the intermediate sub-element may be manufactured by using a model that includes a number of successive 2D cross-sectional slices that together form the 3D intermediate sub-element.

In an embodiment, the intermediate sub-element manufactured from the additive manufacturing process may have surface roughness, surface porosity, internal porosity and cracks. These defects may also include bond failures and cracks at the interfaces between successive cross-sectional deposit layers. Cracks may develop at these interfaces or cut through or across deposit layers due to stresses inherent with the additive manufacturing process and/or the metallurgy of the build material.

A hot isostatic pressing (HIP) finishing process may be used to eliminate internal defects and other surface-connected defects. For components that use hot isostatic pressing (because of the presence of internal defects), an encapsulation process may be used to bridge and cover the surface-connected defects, effectively converting the surface-connected defects into internal defects in preparation for subsequent hot isostatic pressing (HIP) processing. Traditional polishing or milling techniques may also be used to reduce internal passage surface roughness. After the hot isostatic pressing, finishing methods involving brushing, grinding, lapping, polishing, and the like, may be used to produce the finished intermediate sub-element.

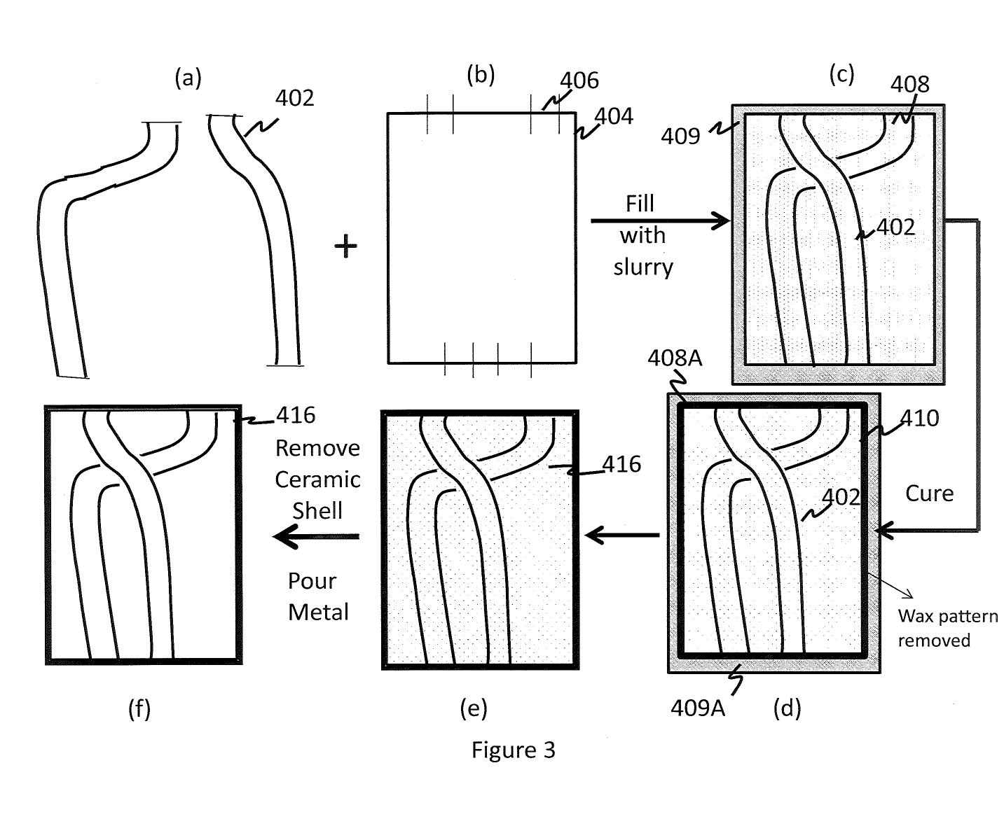

As noted above, the intermediate sub-element may also be manufactured by investment casting. In one embodiment, in one method of manufacturing the intermediate sub-assembly, a wax core (for detailing the hollow portions of the intermediate sub-element) and a ceramic shell are produced separately. A wax outer shape that is hollow in the center 404 (See (b) in the FIG. 3.) that has the shape of the outer surface of the intermediate sub-element is first manufactured. Hollow wax inserts 402 (See (a) in the FIG. 3.) that have the shape of the non-linear passages are placed in the outer wax pattern 404 and secured in place with ends placed on the outer pattern 404. The resulting wax shape is the desired final geometry of the layer multiplier tooling. The holes 406 are located at positions in the wax pattern 404 where the inlet ports will contact the non-linear passages. A ceramic slurry 409 (See (c) in the FIG. 3.) is then disposed to cover all exterior surfaces of the wax pattern 402 and 404. The ceramic slurry 408 is poured into the inside of the hollow inserts. The ceramic slurry 408/409 is then cured and fired to form a ceramic shell 408A/409A (See (d) in the FIG. 3). The wax pattern 404 is then removed (See (d) in the FIG. 3) by melting or chemical etching) to form a ceramic mold that has a space 410 where the wax pattern 404 used to be. Molten metal 416 is then poured into the ceramic mold into the space 410 and allowed to solidify to form the intermediate sub-assembly (See (e) in the FIG. 3). The ceramic mold is then removed leaving the desired metal part (See (f) in the FIG. 3).

In one embodiment, in one method of manufacturing the intermediate sub-element a portion of the intermediate sub-element may be manufactured by investment casting while the other portion may be manufactured by additive manufacturing. A first portion of the intermediate sub-element may be manufactured by investment casting. The first portion is then put in an additive manufacturing device and the remainder of the sub-element is manufactured by additive manufacturing.

The aforementioned methods of manufacturing the intermediate sub-element are advantageous because they facilitate the manufacturing of passages that are non-linear and that have complicated shapes. These methods also allow for retroactive modifications to the intermediate sub-element.

What is claimed is:

1. An interfacial surface generator comprising:
an inlet sub-element comprising a plurality of inlet ports, each inlet port having a rectangular cross-section;
an outlet sub-element comprising outlet ports, each outlet port having a rectangular cross-section; and
an intermediate sub-element comprising one or more non-linear passages that are operative to transport a fluid from the inlet ports to the outlet ports and having a point of contact with the inlet ports and a point of contact with the outlet ports, each non-linear passage having a rectangular cross-section at the point of contact with the inlet ports and a rectangular cross-section at the point of contact with the outlet ports, and wherein the outlet ports are arranged to lie at 90 degrees to the inlet ports though not in the same order.

2. The interfacial surface generator of claim 1, where the inlet sub-element, the outlet sub-element and the intermediate sub-element are a single, unitary, indivisible monolithic piece.

3. The interfacial surface generator of claim 1, where a portion of the perimeter of a cross-sectional area of the non-linear passages is non-linear.

4. The interfacial surface generator of claim 3, where the portion of the perimeter of the cross-sectional area of the non-linear passages is part of a circle or a part of a conical section.

5. The interfacial surface generator of claim 3, where the cross-sectional shape of one of the non-linear passages is a circle.

6. The interfacial surface generator of claim 1, where the shape of the non-linear passages is defined by a spline function.

7. (canceled)

8. (canceled)

9. (canceled)

10. (canceled)

11. (canceled)

12. (canceled)

13. The interfacial surface generator of claim 1, and the shape of each non-linear passage transitions from a rectangular cross-section at the point of contact with the inlet ports to a curved surface at an intermediate position to a rectangular cross-section at the point of contact with the outlet ports.
